(19) United States
(12) Patent Application Publication
(10) Pub. No.: US 2018/0252361 A1
(43) Pub. Date: Sep. 6, 2018

(54) LEVER TYPE GREASE GUN

(71) Applicant: Shuoxing Metal Products (Kunshan) CO., LTD., Jiangsu (CN)

(72) Inventor: Wen-I KUO, Jiangsu (CN)

(73) Assignee: Shuoxing Metal Products (Kunshan) CO., LTD.

(21) Appl. No.: 15/962,835

(22) Filed: Apr. 25, 2018

(30) Foreign Application Priority Data
Mar. 3, 2017 (CN) 201720200868.5

(51) Int. Cl. F16N 3/12

(52) U.S. Cl. CPC F16N 3/12

(57) ABSTRACT

A lever-type grease gun including a hollow cylinder having a first end and a second end opposite to the former; a front-end cover located at the cylinder's the first end and provided with a nozzle part and a mounting portion; a back-end cover located at its second end; an oil pushing rod located at the front-end cover, capable of moving in the front-end cover under push forces and closer to the back-end cover than the mounting portion, and having an oil pushing rod part; and a handle unit comprising a lever having a pivoting part to match the mounting portion, a pressing part and a long displacement hole between the two and a connecting set inserted in the oil pushing rod part and the long displacement holes and moving in the long displacement holes, thus reducing the force required to fill grease.

### BACKGROUND OF THE INVENTION

### 1. Technical Field

The present utility model relates to a grease gun, and more especially, to a lever type grease gun.

### 2. Background of Related Art

The grease guns disclosed in Chinese patents, for instance, CN2152134Y and CN2536887Y, are hand-operated tools for injecting lubrication grease into mechanical equipment. The known structure for a grease gun 10 shown in FIG. 1 mainly consists of a hollow cylinder 11 for storing grease whose opposite ends are threaded for a front-end cover 12 and a back-end cover 13, wherein the front-end cover 12 extends and is formed with a nozzle 121 while it is provided with an oil pushing rod 14 and a handle unit 15, and a piston rod 16 is inserted into the hollow cylinder 11 through the back-end cover 13. Generally, the back end of the grease gun is always for provision of the piston rod 14, so the grease is filled through the front end of the hollow cylinder 11. The oil pushing rod, the piston rod 14 and the handle unit 15 work together to push the grease to and out of the nozzle 121 into the mechanical equipment. However, actually, there are some aspects needing to be improved.

Since the handle unit 15 mainly consists of a link 151 and a lever 152, wherein the first end 1511 of the link 151 is pivoted at the front-end cover 12, the second end 1512 of the link 151 is pivoted at the pivoting part 1521 of the lever 152, and the connecting part 1522 of the lever 152 is pivoted to the oil pushing rod 14 by means of a rivet, and consequently the link 151, the lever 152 and the oil pushing rod 14 are pivoted and the pivoting distances among them do not change during operation, that is, before, during and after pressing the lever 152, the distance L1 between the pivoting part 1521 of the lever 152 as a fulcrum P1 and the connecting part 1522 of the lever 152 as the resistance point P2 as well as the distance L2 between the connecting part 1522 of the lever 152 as the resistance point P2 and the pressing part 1523 of the lever 152 as the point of force application P3 do not change, so it will require the same force to press the pressing part 1523 of the lever 152 to the hollow cylinder 11 during the whole operation of grease filling, clearly showing the disadvantage that strenuous efforts have to be made to operate such a gun.

### BRIEF SUMMARY OF THE INVENTION

The present utility model is to provide a lever-type grease gun with which less effort is needed to fill the grease.

To realize the aim above, a lever-type grease gun according to the present utility comprises a hollow cylinder having a first end and a second end opposite to the first end; a front-end cover located at the first end of the hollow cylinder and provided with a nozzle part and a mounting portion; a back-end cover located at the second end of the hollow cylinder; an oil pushing rod which is located at the front-end cover, capable of moving in the front-end cover under push forces and closer to the back-end cover than the mounting portion, and has an oil pushing rod part; and a handle unit comprising a lever and a connecting set, wherein the lever has a pivoting part to match the mounting portion, a pressing part and a long displacement hole between the pivoting part and the pressing part, while the connecting set is inserted in the oil pushing rod part and the long displacement holes and moves in the long displacement holes.

Preferably, the long displacement hole of the lever has a first long hole emargination and a second long hole emargination away from the pivoting part, wherein the first long hole emargination and the second long hole emargination move closer to or away from the connecting set.

Preferably, the oil pushing rod part of the oil pushing rod is configured as a through-hole, the lever of the connecting set has opposite side rod parts which are at the sides of the oil pushing rod part respectively, and both the side rod parts are made with a long displacement hole, and the connecting set is inserted in the oil pushing rod part and located in the two long displacement holes.

Preferably, the connecting set consists of two connecting shaft sleeves and a connecting pivot, wherein the connecting shaft sleeves are located in the long displacement holes respectively, and the connecting pivot is inserted in the connecting shaft sleeves, the long displacement holes and the oil pushing rod part.

The present utility model provides a lever type grease gun which has the structure design that long displacement holes are made in the lever of the handle unit, the lever is inserted in the oil pushing rod part by means of the connecting set and the oil pushing rod can move in the long displacement holes. The design provides a sliding connection between the oil pushing rod and the lever, that is, the distance between the pivoting part of the lever as the fulcrum and the connecting set as the resistance point as well as the distance between the connecting set as the resistance point and the pressing part of the lever as the point of force application will change before, during and after pressing the lever, thus reducing the force required to fill the grease.

### BRIEF DESCRIPTION OF THE SEVERAL VIEWS OF THE DRAWINGS

FIG. 1 shows the side view of a known grease gun.

FIG. 2 is a solid exploded diagram of one embodiment of the present utility model.

FIG. 3 is a solid assembly diagram of one embodiment of the present utility model.

FIG. 4 is an actuation enlargement of one embodiment of the present utility model, illustrating the status before pressing the lever.

FIG. 5 is an actuation enlargement of one embodiment of the present utility model, illustrating the status during pressing the lever.

FIG. 6 is an actuation enlargement of one embodiment of the present utility model, illustrating the status after pressing the lever.

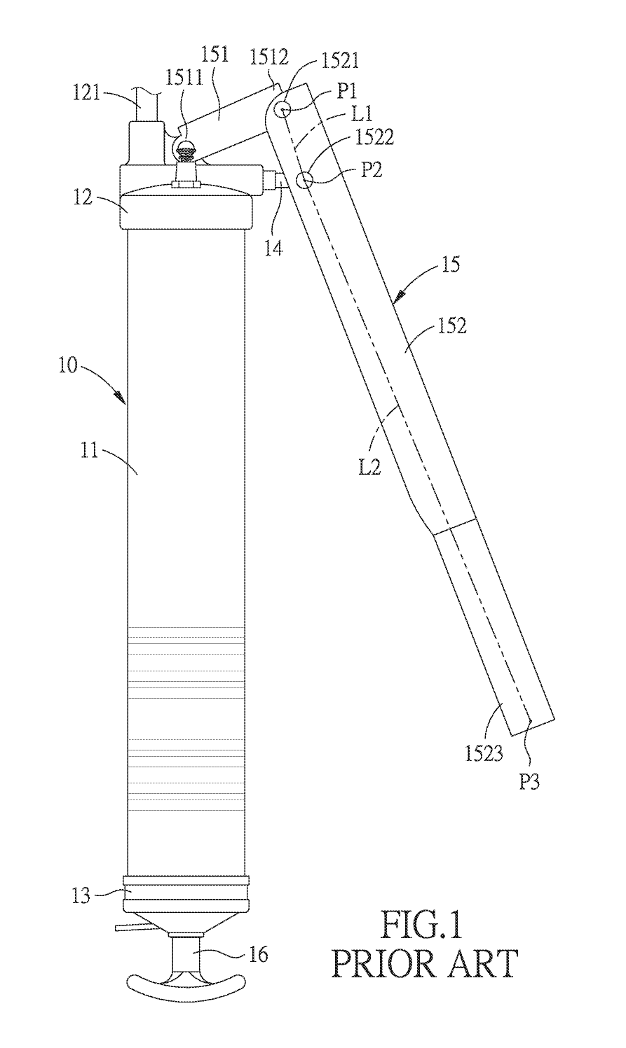

### DETAILED DESCRIPTION OF THE INVENTION

The technical solution of the present utility model will be described hereinafter clearly and entirely, and it is obvious that the embodiments are a part of but not all the embodiments of the present utility model. Any other embodiments obtained by those skilled in this art based on the embodiments of the present utility model without contributing creative labor are all within the protection scope of the present utility model.

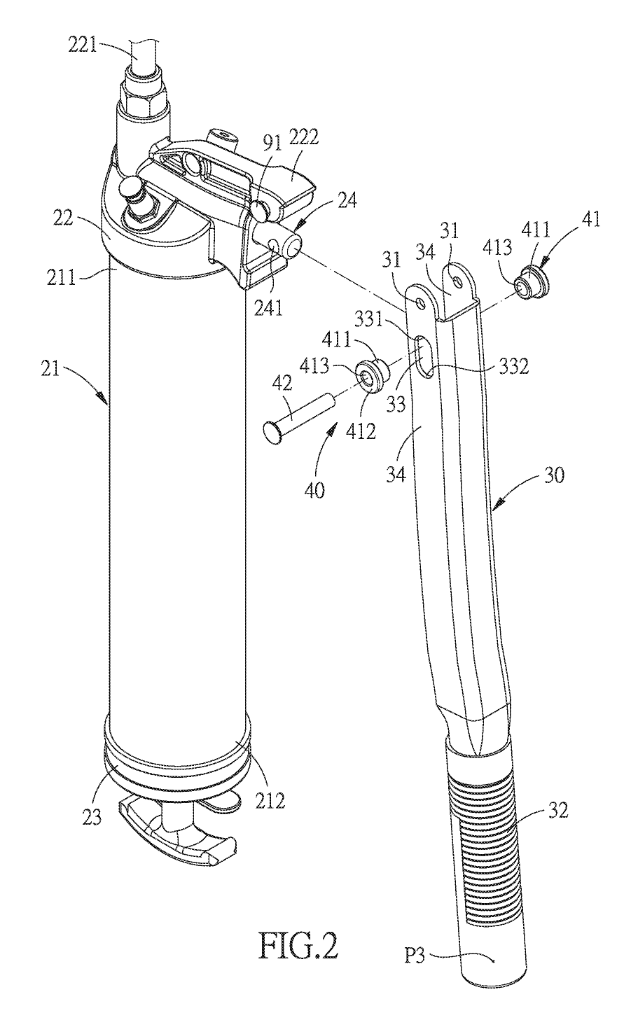

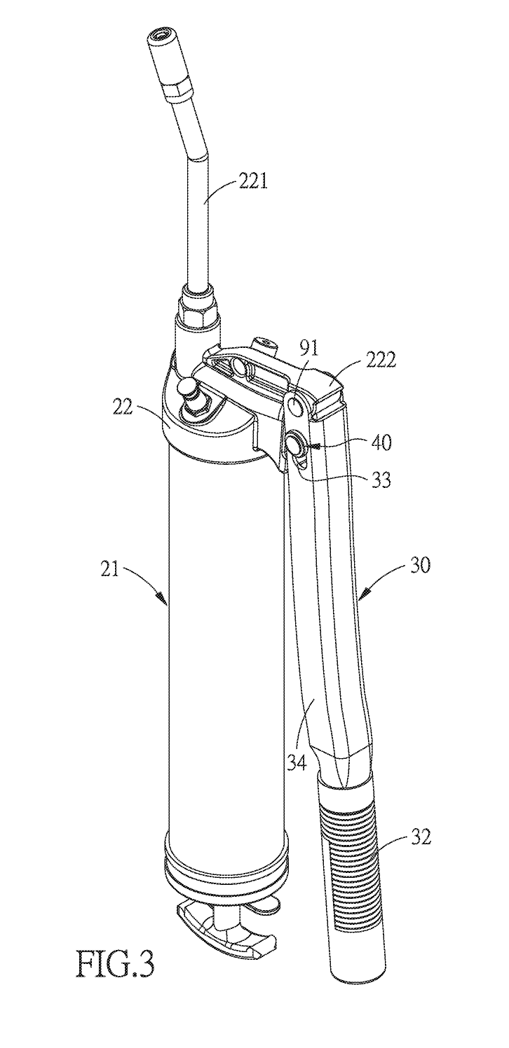

As shown in FIGS. 2-6, a lever type grease gun according to the present utility model main comprises a hollow cylinder 21, a front-end cover 22, a back-end cover 23, an oil pushing rod 24 and a handle unit, wherein:

the hollow cylinder 21 has a first end 211 and a second end 212 opposite to the first end 211;

the front-end cover 22 is located at the first end 211 of the hollow cylinder 21 and provided with a nozzle part 221 and a mounting portion 222;

the back-end cover 23 is located at the second end 212 of the hollow cylinder 21;

the oil pushing rod 24 is located at the front-end cover 22, capable of moving in the front-end cover under push forces and closer to the back-end cover 23 than the mounting portion 222, and has an oil pushing rod part 241; in the embodiment, the oil pushing rod part 241 is configured as a through-hole. Since the oil pushing rod 24 is a known member and its actuation mode is also well known, so they are not the key creation points of the present utility model, and no details will be provided for the actuation mode of this member herein.

The handle unit comprises a lever 30 and a connecting set 40, wherein:

the lever 30 has a pivoting part 31 to match the mounting portion 222, a pressing part 32 and a long displacement hole 33 between the pivoting part 31 and the pressing part 32. In the embodiment, the lever 30 has opposite side rod parts 34 which are at the sides of the oil pushing rod part 241 respectively, both the side rod parts 34 are made with a long displacement hole 33, each long displacement hole 33 extends in the length of the lever 30 and has a first long hole emargination 331 and a second long hole emargination 332 away from the pivoting part 31; in addition, the side rod parts 34 are made with a pivoting part 31 in the form of a hole which is pivoted at the mounting portion 222 of the front-end cover 22 by means of a through-going shaft 91, so that the lever 30 is pivoted at the front-end cover 22 and the pressing part 32 can move closer to and away from the hollow cylinder 21.

The connecting set 40 connects the oil pushing rod 24 and lever 30 as a pivot, is inserted in the oil pushing rod part 241 and the two long displacement holes 33 and moves in the two long displacement holes 33, moves closer to or away from the first long hole emargination 331 and the second long hole emargination 332; in the embodiment, the connecting set 40 consists of two connecting shaft sleeves 41 and a connecting pivot 42, wherein the connecting shaft sleeves 41 are located in the long displacement holes 33 respectively, each connecting shaft sleeve has a guiding part 411 inserted in the long displacement hole 33, an expansion part 412 connecting the guiding part 411 and located at the outer side of the edge of the long displacement hole 33, and a perforation part 413 running through the guiding part 411 and the expansion part 412; the connecting pivot 42 is inserted in the perforation parts 413 of the connecting shaft sleeves 41, the long displacement holes 33 and the oil pushing rod part 241, wherein the connecting pivot 42 is connected together with the connecting shaft sleeves 41, the lever 30 and the oil pushing rod 24 through riveting.

The structure and configuration of the main members of the embodiment of the present utility model are described above.

The present utility model provides a lever type grease gun which has the structure design that long displacement holes 33 are made in the lever 30 of the handle unit, the lever is inserted in the oil pushing rod part 241 by means of the connecting set 40 and the oil pushing rod can move in the long displacement holes 33. The design provides a sliding connection between the oil pushing rod 24 and the lever 30, that is, the distance between the pivoting part 31 of the lever 30 as the fulcrum P1 and the connecting set 40 as the resistance point P2 as well as the distance between the connecting set 40 as the resistance point P2 and the pressing part 32 of the lever 30 as the point of force application P3 will change before, during and after pressing the lever 30, thus reducing the force required to fill the grease.

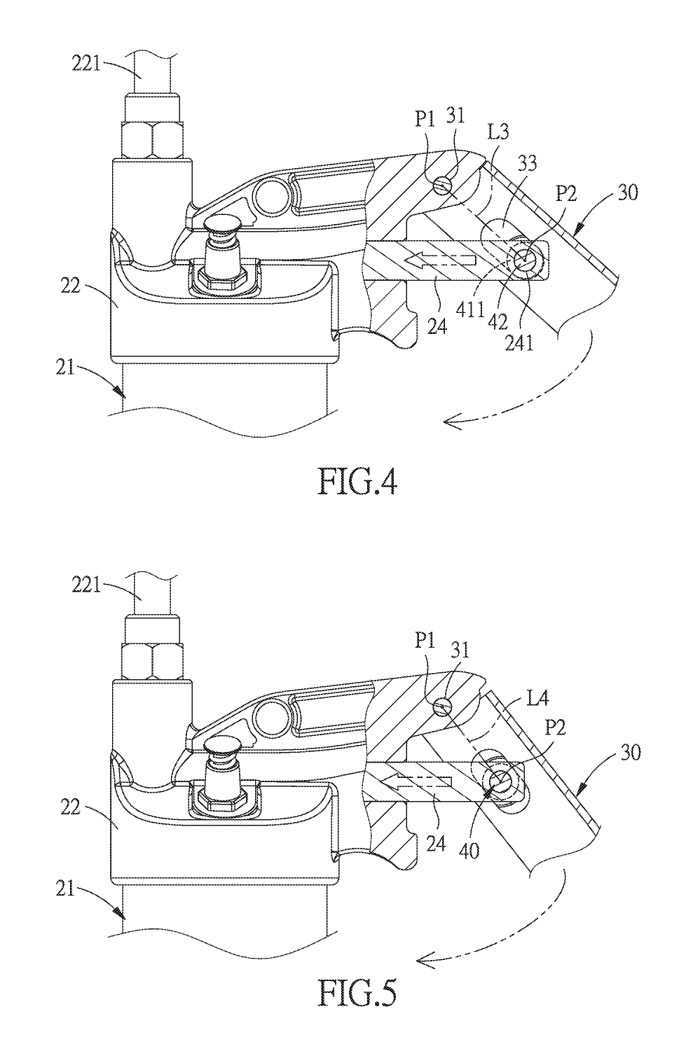

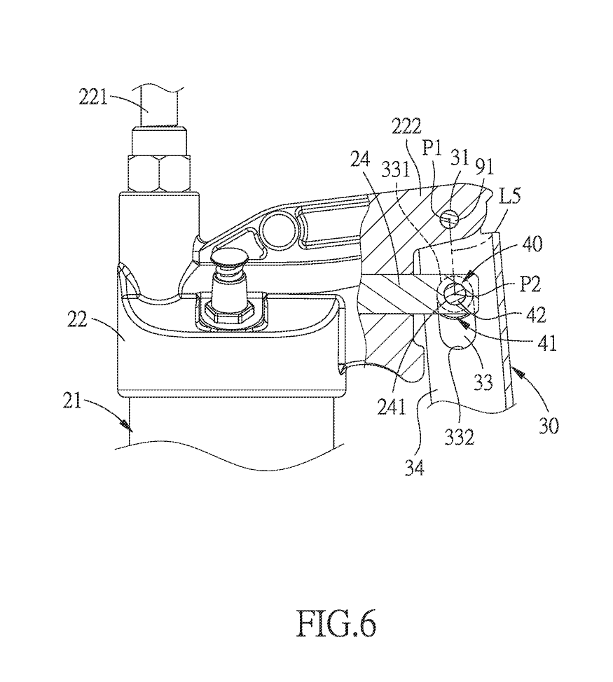

FIG. 4 shows the status of the present utility model before pressing the lever. In this status, the distance between the pivoting part 31 of the lever 30 as the fulcrum P1 and the connecting set 40 as the resistance point P2 is assumed as L3. FIG. 5 shows the status of the present utility model before and during pressing the lever. In this status, the distance between the pivoting part 31 of the lever 30 as the fulcrum P1 and the connecting set 40 as the resistance point P2 is assumed as L4. FIG. 6 shows the status of the present utility model before and after pressing the lever. In this status, the distance between the pivoting part 31 of the lever 30 as the fulcrum P1 and the connecting set 40 as the resistance point P2 is assumed as L5. We can clearly know from FIG. 4 to FIG. 6 that the distances L3, L4 and L5 (resistance arm) between the pivoting part 31 of the lever 30 as the fulcrum P1 and the connecting set 40 as the resistance point P2 are gradually decreasing before, during and after pressing the lever 30, so the force required on the lever 30 before, during and after pressing are also gradually decreasing, thus reducing the force required to fill the grease.

In addition, we can clearly know from FIG. 4 to FIG. 6 that the distances L3, L4 and L5 (resistance arm) between the pivoting part 31 of the lever 30 as the fulcrum P1 and the connecting set 40 as the resistance point P2 are gradually decreasing before, during and after pressing the lever 30. From this, we can know that the distance (arm of force application) between the connecting set 40 as the resistance point P2 and the pressing part 32 of the lever 30 as the point of force application P3 is gradually increasing, thus further reducing the force required to fill the grease.

To sum up, the foregoing embodiments and figures are only used as preferred embodiments of the present utility model and are not intended to limit the protection scope of the utility model, and any modifications, equivalent substitutions and improvements based on the spirit and principle of the utility model shall be covered in the protection scope of the present utility model.

What is claimed is:

1. A lever type grease gun, characterized in that it comprises:
a hollow cylinder, having a first end and a second end opposite to the first end;
a front-end cover, located at the first end of the hollow cylinder and provided with a nozzle part and a mounting portion;
a back-end cover, located at the second end of the hollow cylinder;
an oil pushing rod, located at the front-end cover, capable of moving in the front-end cover under push forces and closer to the back-end cover than the mounting portion, and having an oil pushing rod part; and
a handle unit, comprising a lever and a connecting set, wherein the lever has a pivoting part to match the mounting portion, a pressing part and a long displacement hole between the pivoting part and the pressing part, while the connecting set is inserted in the oil pushing rod part and the long displacement holes and moves in the long displacement holes.

2. The lever type grease gun as claimed in claim 1, characterized in that the long displacement hole of the lever has a first long hole emargination and a second long hole emargination away from the pivoting part, wherein the first long hole emargination and the second long hole emargination move closer to or away from the connecting set.

3. The lever type grease gun as claimed in claim 1, characterized in that the oil pushing rod part of the oil pushing rod is configured as a through-hole, the lever of the connecting set has opposite side rod parts which are at the sides of the oil pushing rod part respectively, and both the side rod parts are made with a long displacement hole, and the connecting set is inserted in the oil pushing rod part and located in the two long displacement holes.

4. The lever type grease gun as claimed in claim 2, characterized in that the oil pushing rod part of the oil pushing rod is configured as a through-hole, the lever of the connecting set has opposite side rod parts which are at the sides of the oil pushing rod part respectively, and both the side rod parts are made with a long displacement hole, and the connecting set is inserted in the oil pushing rod part and located in the two long displacement holes.

5. The lever type grease gun as claimed in claim 3, characterized in that the connecting set consists of two connecting shaft sleeves and a connecting pivot, wherein the connecting shaft sleeves are located in the long displacement holes respectively, and the connecting pivot is inserted in the connecting shaft sleeves, the long displacement holes and the oil pushing rod part.
